(19) United States
(12) Patent Application Publication
(10) Pub. No.: US 2022/0109566 A1
(43) Pub. Date: Apr. 7, 2022

(54) Encryption And Decryption Method And Device Based On Random Hash And Bit Operation

(71) Applicants: Jilin University, Changchun (CN); Zhuhai College of Science And Technology, Zhuhai (CN)

(72) Inventors: Yujuan SI, Zhuhai (CN); Guanghui FENG, Zhuhai (CN); Liuqi LANG, Zhuhai (CN); Xiaoyang FU, Zhuhai (CN); Hao WU, Zhuhai (CN)

(73) Assignees: Jilin University, Changchun (CN); Zhuhai College of Science And Technology, Zhuhai (CN)

(21) Appl. No.: 17/428,569

(22) PCT Filed: Apr. 19, 2019
(86) PCT No.: PCT/CN2019/083405

§ 371 Date: Aug. 4, 2021

(30) Foreign Application Priority Data
Feb. 18, 2019 (CN) 201910119851.0

(51) Int. Cl. H04L 9/08; H04L 9/06

(52) U.S. Cl. CPC H04L 9/0869; H04L 9/0643; H04L 9/0618

(57) ABSTRACT

Disclosed are an encryption and decryption method and device based on a random hash and bit operation. The method includes the steps of: S1: configuring a memory space, and preparing corresponding storage spaces for a plaintext file, a ciphertext file, and a key file, wherein the key file comes from an existing coding sequence and serves as a shared file for encryption and decryption; S2: providing a reversible hash function set used for encryption and decryption, and then uniformly scattering the plaintext in a known binary random hash by an encryption hash function; and S3: introducing a bit operation rule set, changing values of all or partial binary bits of the binary random hash by a bit operation, and mapping the values to a ciphertext space. The device includes a memory and a processor, and is configured to implement the above method.

### TECHNICAL FIELD

The present invention relates to an encryption and decryption method and device based on a random hash and bit operation, and belongs to the field of digital communication technologies and information encryption. The present invention may be generally used for encrypting network communication information, aerospace digital remote-control instruction and data, unmanned aerial vehicle digital remote control communication data, airborne early warning aircraft digital communication command system information, GPS satellite digital communication data, mobile phone communication, e-mail, electronic financial data transmission, and the like. In the aspect of image coding, images of various formats may be encrypted, so that the intellectual property rights of the images are protected. After encrypting military, political and diplomatic documents, the documents may be transmitted by a civil communication network, thus saving a cost of file transmission.

### BACKGROUND

Stream cipher is generally a symmetric key technology, which has become an important cryptosystem due to the advantages of simple implementation, fast encryption speed, and no spread of errors generated in ciphertext transmission in a plaintext. At present, the stream cipher technology still maintains its advantages in confidential institutions and mobile communication fields, and is one of the most popular cryptosystems today. In order to ensure information security, the research and development, and design of many stream cipher technologies are basically performed in a confidential state. Countries often restrict the export of stream cipher technologies and products as military products.

Core idea of the stream cipher is to generate a pseudo-random sequence with an excellent performance, which is namely a key stream for encryption and decryption. The design of a key stream generator is a key for security of the stream cipher. At present, common methods for generating the pseudo-random sequence in a design scheme of the stream cipher are as follows: a linear shift register; S-case permutation technology; a clock control sequence; a combined network sequence; a cellular automaton; a chaos theory; and the like. Well-known stream cipher algorithms include: A5 algorithm in a GSM mobile communication system, RC4 algorithm in a WEP standard of IEEE802.11, ZUC algorithm used by 3GPP as an international standard, SNOW 3G algorithm in a LTE system, E0 algorithm in Bluetooth technology, and the like.

These methods have been open secrets, and now research on attacking and decrypting these methods is being conducted by many scholars. In 2003, Courtois and Meier applied an algebraic attack to a stream cipher algorithm based on a linear feedback shift register, and the “algebraic attack” analyzed a security of a cryptosystem from a new angle, and was transformed into solving a problem of an overdetermined multivariable equation. In 2004, Hoch et al. put forward to introduce an attack method for an error of the RC4 algorithm. In addition, the common attack means for the stream cipher technology further include guessing decision attack, fast correlation attack, cube attack, and the like.

In recent years, the rapid development of stream cipher attack technology has brought great challenges and impacts on the design and development of stream cipher system.

In addition, the conventional stream cipher technology is based on a bit exclusive-or operation, which means that a ciphertext is generated by a bit exclusive-or operation between a plaintext and a key, and then the plaintext is decrypted by an exclusive-or operation between the ciphertext and the key. This method has a serious defect in that security strength of the stream cipher system completely depends on security strength of the key stream.

### SUMMARY

In the method of the present invention, by means of an existing known coding sequence (which may be called a true random sequence) used as an initial key stream, there is no strict requirement on a cycle duration and a randomness of the initial key stream. The initial key stream may come from various types of files, such as a text file, an audio, a video, and a picture, and may also come from pseudo-random sequences and various chaotic signals generated by various key stream generators. In the method, the key stream generator is composed of a bit operation rule set, and an output sequence obtained after preprocessing the initial key stream by the key stream generator is used as an encryption and decryption key. In a process of traversing a plaintext in one pass, a pseudo-plaintext stream is obtained by changing a bit value of the plaintext according to a bit operation rule depending on (or not depending on) the key stream, and meanwhile, the pseudo-plaintext stream is randomly mapped to a ciphertext space according to a hash rule to obtain a ciphertext. The present invention also provides several dynamic direct addressing methods for constructing the hash rule set.

A difference between the present method and a conventional stream cipher technology is that: the present method is based on a dynamic hash and bit operation of a plaintext sequence on a binary system instead of an exclusive-or operation, so that security of a stream cipher not only depends on the key stream, but also depends on the dynamic hash rule and the bit operation rule, thus having a higher security. It is difficult to decrypt the present method by an exhaustive method mathematically, because a number of times of exhaustion should be 8 times the second power of a number of bytes (N) of the plaintext, which is namely 2^{8×N}.

A first aspect of the technical solution of the present invention is an encryption and decryption method based on a random hash and bit operation, which includes the following steps of:

S1: configuring a memory space, and preparing corresponding storage spaces for a plaintext file, a ciphertext file, and a key file, wherein the key file comes from an existing coding sequence and serves as a shared file for encryption and decryption;

S2: providing a reversible hash function set used for encryption and decryption, and then uniformly scattering the plaintext in a known binary random hash by an encryption hash function; and

S3: introducing a bit operation rule set, changing values of all or partial binary bits of the binary random hash by a bit operation, and mapping the values to a ciphertext space.

Further, the step S1 includes: initializing the plaintext file, loading the plaintext file needing to be encrypted, and setting a number of element codes of the key file, wherein a byte length of the key file is customizable, and further the number of the element codes of the key file is no more than a number of element codes of the plaintext file. The coding sequence generating the key file comes from at least one of an audio, a video, a picture, an image, a graph, a pseudo-random code, or a chaotic value.

Further, the step S2 includes: constructing the hash function set by a dynamic direct addressing method to avoid collision, so that a dictionary attack technique for the hush function is invalid.

Further, the step S2 further includes providing an algorithm program of encryption and decryption algorithm program sets to perform displacement reading on the plaintext file, the ciphertext file, and the key file by. An element of the encryption algorithm set is a hash function and bit operation rule set for an encryption operation; and an element of the decryption algorithm set is a hash function and bit operation rule set for a decryption operation. Any hash function and bit operation rule in the encryption algorithm set has a unique hash function and bit operation rule in the decryption algorithm set which is corresponding and reversible to the hash function and bit operation rule.

Further, the step S3 includes: negating partial or all binary bits of the plaintext or a key, and by means of pseudo-random sequences and chaotic signals generated by various key stream generators, and by means of various Boolean functions and any random files with uniform code distribution on a binary system, configuring a bit operation rule.

Further, in the step S3, the bit operation rule includes at least one of the following operation rules: according to a true value bit or a false value bit of the key stream, negating partial binary bits of the plaintext; according to various Boolean functions, negating partial binary bits of the plaintext; according to a true value bit or a false value bit of another key stream, negating partial binary bits of an initial key stream; and according to various Boolean functions, negating partial binary bits of the initial key stream.

Preferably, the Boolean function includes a combination of one or more mathematical formulas. For example, a specific bit meeting a formula of |C+X×i| MOD Y=Z is negated in a traversing process, wherein i is a serial number of the binary bit, C and X are integers, Y is a positive integer, and Z is an integer greater than or equal to 0 and less than Y, the specific bit includes an odd bit, an even bit, and a binary bit with a remainder being zero when divided by a certain prime number Y.

Further, the method further includes: creating a plaintext encrypted random number, a ciphertext encrypted random number, and a key encrypted random number correspondingly for the plaintext file, the ciphertext file, and the key file respectively, and generating corresponding working pointers according to values of the encrypted random numbers; performing working pointer displacement reading on the plaintext file, the ciphertext file, and the key file; and circularly traversing the working pointer for a plurality of times, and according to a value of the binary bit of the key stream pointed by the working pointer, iterating the plaintext file for a plurality of times to obtain the ciphertext file.

Further, the method further includes: implementing the plaintext, a key, and a ciphertext by a round-robin queue structure; allowing a length of the key file to be not necessarily equal to that of the plaintext file; and intercepting partial bytes of the key file as the key, or using a circular key.

A second aspect of the technical solution of the present invention is a computer device, including a memory, a processor, and a computer program stored on the memory and executable on the processor, wherein the processor, when executing the program, implements the above steps.

A third aspect of the technical solution of the present invention is a computer-readable storage medium storing a computer program that, when executed by a processor, implements the above steps.

Features of the technical solution of the present invention are as follows.

1. The present method is simple, but is extremely difficult to be decrypted.

2. Without any auxiliary hardware device, the method is easy to be implemented by using a computer algorithm and programming.

3. The method has a good time performance, and time complexity of the method is O(len(M)), which is consistent with that of a traditional stream cipher method, wherein len(M) is a length of the plaintext.

4. There is no traditional one-to-one and one-to-many relationship between the plaintext and the ciphertext in the present method. Disordered encryption is employed, which means that a relationship between the plaintext and the ciphertext is the most complex many-to-many relationship.

5. Code distribution uniformity of the ciphertext generated by the present method is much higher than that of the ciphertext generated by the traditional stream cipher method.

6. The present method has no strict requirement on randomness of the initial key stream and code distribution uniformity, and even if the initial key stream failed in various randomness tests (such as 16 tests of National Institute of Standards and Technology (NIST)) is used, an encryption effect of the present method is still much higher than that of the traditional method. However, with an increase of a cycle duration of the key stream sequence and an increase of uniformity, encryption effect and complexity of the present method are also improved.

7. Transmission can be performed in the existing public communication channel.

8. The plaintext is encrypted, sent, and received, and a three-separation principle is used in decryption, so that the security system is safer.

9. The technology follows a one-time pad cryptosystem proposed by Shannon.

### BRIEF DESCRIPTION OF DRAWINGS

FIG. 1 is an overall flow chart of a method according to the present invention.

FIG. 2 is a schematic diagram of an encryption process according to an embodiment of the present invention.

FIG. 3 is a schematic diagram of a decryption process according to e embodiment of the present invention.

### DETAILED DESCRIPTION

The concepts, the specific examples, the specific embodiments, and the technical effects produced of the present invention will be clearly and completely described in conjunction with the embodiments and the accompanying drawings so as to sufficiently understand the objects, the solutions and the effects of the present invention.

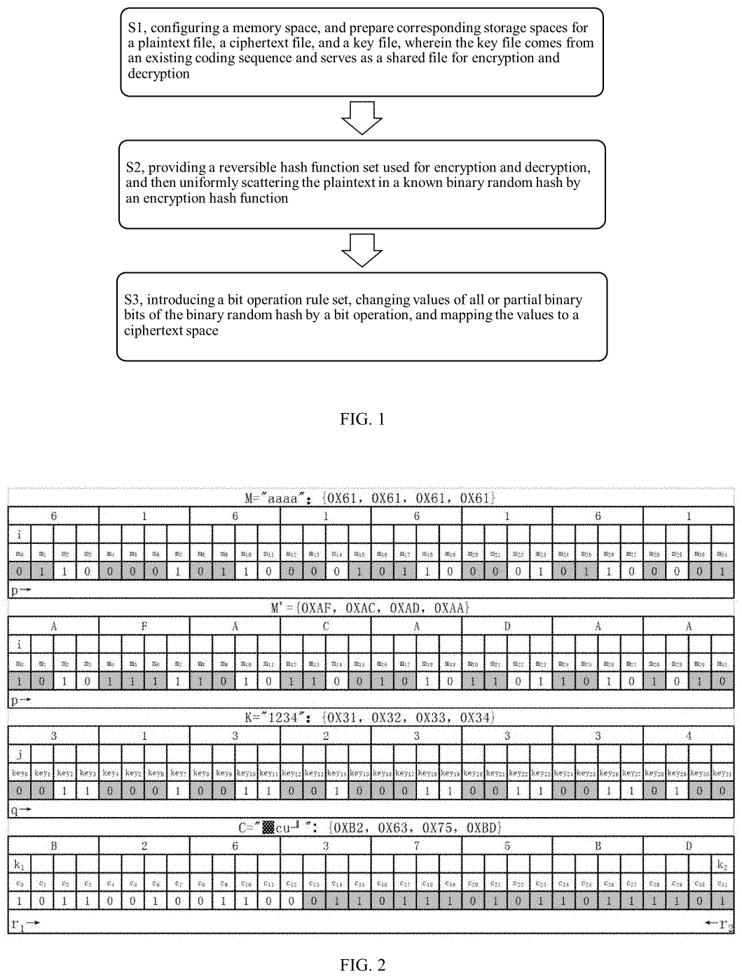

In encryption and decryption solutions of the present invention, the encryptor and the decryptor are designed based on a hash function. In an encryption process, a plaintext is uniformly scattered in a known binary random hash by means of a key, and all or partial plaintext is subjected to a bit operation according to a mapping relationship of a hash function, and then mapped to a ciphertext space. With reference to FIG. 1, a method according to the present invention includes steps of: S1: configuring a memory space, and preparing corresponding storage spaces for a plaintext file, a ciphertext file, and a key file, wherein the key file comes from an existing coding sequence and serves as a shared file for encryption and decryption; S2: providing a reversible hash function set used for encryption and decryption, and then uniformly scattering the plaintext in a known binary random hash by an encryption hash function; and S3: introducing a bit operation rule set, changing values of all or partial binary bits of the binary random hash by a bit operation, and mapping the values to a ciphertext space.

When a special signal, such as all 0 or all 1 in value, is transmitted, the special signal is easy to be decrypted if only depending on the hash function for encryption. In the solution of the embodiment, introduction of the bit operation rule can avoid such situation. By using the method, not only a ciphertext in discrete distribution can be obtained, but also a code uniformity of the ciphertext is much higher than that of the plaintext by using a hash function and a bit operation. By designing different hash functions and bit operation rules, encryption and decryption algorithm sets are formed, and an uncertainty of the hash function, the bit operation rule, and the key is an advantage of the algorithm.

Based on a data stream encryption technology, the algorithm is an encryption system of binary stream discrete bit mapping established by depending on the key. A quintuple group (M, C, K, E, D) is used in the encryption system as a theoretical basis of encryption and decryption. In the quintuple group proposed herein, M is a plaintext code element set, C is a cipher code element set, P is a reference byte code element set (also called a key set), E is an encryption algorithm set, and D is a decryption algorithm set. These sets have the following characteristics.

1. M={M₀, M₁, . . . , M_{len(M)-1}}={m₀, m₁, . . . m_{8len(M)-2}, m_{8×len(M)-1}}, wherein len(M) is a number of bytes of the plaintext, and 8× len(M) is a number of binary bits of the plaintext; Mᵢ(i∈[0, len(M)−1]) is a byte of the plaintext; and mⱼ∈{0,1}, j∈[0,8× len(M)−1] is a binary bit of the plaintext.

2. K={K₀, K₁, . . . , K_{len(K)-1}}={key₀, key₁, . . . , key_{8len(K)-2}, key_{8×len(K)-1}}, wherein len(K) is a number of bytes of the key, and 8× len(K) is a number of binary bits of the key; Kᵢ(i∈[0, len(K)−1]) is a byte of the key; and keyⱼ∈{0,1}, j∈[0,8× len(K)−1] is a binary bit of the key.

3. C={C₀, C₁, . . . , C_{len(C)-1}}={c₀, c₁, . . . , c_{8len(C)-2}, c_{8×len(C)-1}}, wherein len(C) is a number of bytes of the ciphertext, len(C)=len(M) means that a length of the plaintext is equal to that of the ciphertext, and 8× len(C) is a number of binary bits of the ciphertext; Cᵢ(i∈[0, len(C)−1]) is a byte of the ciphertext; and cⱼ∈{0, 1}, j∈[0,8× len(C)−1] is a binary bit of the ciphertext.

4. Information in M, K and C sets is a byte character set composed of binary code elements {0, 1}, wherein numbers of the code elements {1} in the sets are respectively recorded as sum(M), sum(K), and sum(C), and sum(M) is not necessarily equal to sum(C).

5. Elements of the encryption algorithm set E are hash function and bit operation rule sets for an encryption operation.

6. Elements of the decryption algorithm set D are hash function and bit operation rule sets for a decryption operation. Any hash function and bit operation rule in the set E should have a unique hash function and bit operation rule in the set D which is corresponding and reversible to the hash function and bit operation rule.

The encryption and decryption solutions of the present invention are described by more embodiments hereinafter.

### I. ENCRYPTION EXAMPLE (ALL THE FOLLOWING EXAMPLES ARE BASED ON ENCRYPTION AND DECRYPTION METHOD 1)

### Example 1

Assuming that all files use an extended ASCII code (an IBM extended character set)^{[24]} as a coding mode, according to an encryption algorithm shown in the method 1, the plaintext M in Example 1 is hashed and addressed through the key K first, and then the ciphertext C is finally obtained by a bit operation.

$$M = \{ “ aaaa ” \} = {\{ 0 X 61 , 0 X 61 , 0 X 61 , 0 X 61 \}}_{16} = {\{ 01100001 , 01100001 , 01100001 , 01100001 \}}_{2} . \\ {M}^{′} = {\{ 0 XAF , 0 XAC , 0 XAD , 0 XAA \}}_{16} = {\{ 10101111 , 10101100 , 10101101 , 10101010 \}}_{2} . \\ K = \{ “ 1234 ” \} = {\{ 0 X 31 , 0 X 32 , 0 X 33 , 0 X 34 \}}_{16} = {\{ 00110001 , 00110010 , 00110011 , 00110100 \}}_{2} . \\ C = \{ “ ” \} = {\{ 0 XB 2 , 0 X 63 , 0 X 75 , 0 XBD \}}_{16} = {\{ 10110010 , 01100011 , 01110101 , 10111101 \}}_{2} .$$

Please note that “ [symbol] ” is a specific character generated during transcoding in encryption instead of a messy code.

An encryption example specifically refers to FIG. 2.

1. M={“aaaa”} represents a plaintext, and is an input sequence for encryption. {0X61, 0X61, 0X61, 0X61} is an ASCII code (a hexadecimal system) of the plaintext “aaaa”, which is converted into a binary system to obtain {01100001, 01100001, 01100001, 01100001}.

2. M′ represents a pseudo-plaintext sequence generated after negating partial binary bits of the plaintext according to specific bits (“false” value binary bits) of the key bit by bit. {0XAF, 0XAC, 0XAD, 0XAA} is an extended ASCII code (a hexadecimal system) of M′, which is converted into a binary system to obtain {10101111, 10101100, 10101101, 10101010}.

3. K={“1234”} represents the key. {0X31, 0X32, 0X33, 0X34} is an ASCII code (a hexadecimal system) of the key “1234”, which is converted into a binary system to obtain {00110001, 00110010, 00110011,00110100}.

4. C={“ [symbol] ”} represents the ciphertext, and is an encrypted output sequence. {0XB2, 0X63, 0X75, 0XBD} is an extended ASCII code (a hexadecimal system) of the ciphertext “ [symbol] ”, which is converted into a binary system to obtain {10110010, 01100011, 01110101, 10111101}.

5. The plaintext, the key, and the ciphertext all use a logical structure of a round-robin queue, which may be calculated at any position in the queue, and initial values are now taken as i=0, j=0, k₁=0, and k₂=31. A working pointer p points to a plaintext M[0], q points to a key K[0], and r₁ and r₂ point to ciphertexts C[0] and C[31]. An encryption process is shown in FIG. 1.

6. According to a value of a binary bit of the key K, a hash function enHash of the encryption algorithm is applied to obtain a binary bit p of the plaintext corresponding to a binary bit q of a “true” value of the key, wherein the binary bit of the plaintext is negated and then mapped to a ciphertext space r₁, and is filled from left to right; and a binary bit p of the plaintext corresponding to a binary bit q of a “false” value of the key, wherein the binary bit of the plaintext is negated and then mapped to a ciphertext space r2, and is filled from right to left.

7. Gray shading parts in the key K represent “false” value parts, gray shading parts in the plaintext M represent plaintexts corresponding to the “false” value parts of the key K, and gray shading parts in the pseudo-plaintext sequence M′ are results of negating the gray shading parts in the plaintext M bit by bit. M′ is mapped to the ciphertext space according to an encryption hash function to obtain the ciphertext C.

### Example 2

Assuming that all files use the extended ASCII code (the IBM extended character set) as the coding mode, according to the encryption algorithm shown in the method 1, the plaintext M in Example 2 is hashed and addressed through the key K first, and then the ciphertext C is finally obtained by the bit operation.

$$M = \{ {“}^{⋀ \_ \vert} c ” \} = {\{ 0 X 5 E , 0 X 09 , 0 XD 9 , 0 XE 3 \}}_{16} = {\{ 01011111 , 00001001 , 11011001 , 01100011 \}}_{2}$$

$$K = \{ “ 1234 ” \} = {\{ 0 X 31 , 0 X 32 , 0 X 33 , 0 X 34 \}}_{16} = {\{ 00110001 , 00110010 , 00110011 , 00110100 \}}_{2}$$

$$C = \{ “ aaaa ” \} = {\{ 0 X 61 , 0 X 61 , 0 X 61 , 0 X 61 \}}_{16} = {\{ 01100001 , 01100001 , 01100001 , 01100001 \}}_{2}$$

wherein: (1) 0X09 in the plaintext M is a positioning function key, which is not displayed as a character; and (2) enumeration of M′ is omitted herein.

### Example 3

In Example 3, each file is saved as a text file (default ANSI encoding), so that the key set K and the ciphertext set C are displayed as Chinese characters. According to the encryption algorithm shown in the method 1, the ciphertext obtained by encrypting 256 “a” of the plaintext M through the key K in Example 3 has as many as 138 different codes (this value varies with the algorithm and the key), which means that the plaintext coded as 01100001 (an ASCII code of a) corresponds to 138 different eight-bit binary codes after being encrypted by the algorithm. When saved as a text file, the ciphertext is displayed as the following set C.

M={“aaaaaaaaaaaaaaaa . . . aaaaaaaaaaaaaaa”} (256 a in total)

K={“ [symbol] 0˜Gq* [symbol] 19F&| [symbol] w1o4M* [symbol] J4a8+ [symbol] r2 [symbol] 5E [symbol] f2% S [symbol] U2=”}

C={“BXN [symbol] B [symbol] K3P [symbol] P? [symbol] 2a7 [symbol] 24f?, □E a; 2d [symbol] 71

O %, dh [symbol] 2YB [symbol] $d [symbol] 2b [symbol] X [symbol] d [symbol] ?% [symbol] H [symbol] d?< [symbol] 5

[symbol]

2(K [symbol] ?{ [symbol] z [symbol] □o [symbol] & [symbol] □□ No [symbol] v [symbol] k [symbol] 7 [symbol] [symbol] k [symbol] sku [symbol] yoZ [symbol] o5 [symbol] o [symbol] e [symbol] n [symbol] □”}

C_old={“□Q&K

[symbol]

X′G□PU,K [symbol] +U YJ [symbol] S [symbol] T$ [symbol] SD2 [symbol] 4S\□ Q&K [symbol]
X′G□PU,K [symbol] +U YJ [symbol] S [symbol] T$ [symbol] SD2 [symbol] 4S\□ Q&K [symbol]
X′G□PU,K [symbol] +U YJ [symbol] S [symbol] T$ [symbol] SD2 [symbol] 4S\□ Q&K [symbol]
X′G□PU,K [symbol] +U YJ [symbol] S [symbol] T$ [symbol] SD2 [symbol] 4S\□ Q&K [symbol]
X′G□PU,K [symbol] +U YJ [symbol] S [symbol] T$ [symbol] SD2 [symbol] 4S\□ Q&K

[symbol]

### X′G□”}

wherein:

(1) M represents a plaintext with a total of 256 bytes “a”, is stored as the text file, and is an input sequence for encryption.

(2) Enumeration of M′ is omitted herein.

(3) K represents a key including the character “ [symbol] 0˜Gq* [symbol] 19F&| [symbol] w1o4M* [symbol] J4a8+ [symbol] r2 [symbol] 5E [symbol] f2%S [symbol] U2=”, is stored as a text file, and includes a total of 48 different binary codes if calculated in bytes.

(4) C represents a ciphertext obtained through encrypting by the present method, is stored as a text file, and is an encrypted output sequence, which contains a total of 138 different binary codes if calculated in bytes.

(5) C_old represents a ciphertext obtained by an original stream cipher method based on an exclusive-or operation, is stored as a text file, and is an encrypted output sequence, which contains a total of 48 different binary codes if calculated in bytes.

(6) An overall level of a number of binary codes of different ciphertexts obtained by the present method is higher than that of the original stream cipher method based on the exclusive-or operation, which means that code distribution of the ciphertext obtained by the present method is more uniform.

A formula for calculating a uniformity λ of symbol distribution in a file is as follows^{[25}]:

$$λ = {\sum }_{i = 1}^{r} {( {α}_{i} - \frac{n}{r} )}^{2} \qquad ( formula 1 )$$

wherein, αᵢ represents a number of times of appearance of an i^{th} symbol in the file; n represents a total number of symbols in the file; a total number r of different symbols (codes) is 256 if calculated in bytes; and n/r represents an expected value of various symbols uniformly appearing in all 256 codes. The smaller the value of λ calculated through the formula 1 is, the more uniform the distribution of the symbols is.

For the example, a value range of λ is [0, 65280]; a uniformity λ of the ciphertext C is calculated to be 402; and a uniformity λ of the ciphertext C_old is calculated to be 1430. The above calculation results show that the ciphertext encrypted by the present method has a better code distribution uniformity.

### II. Decryption Example

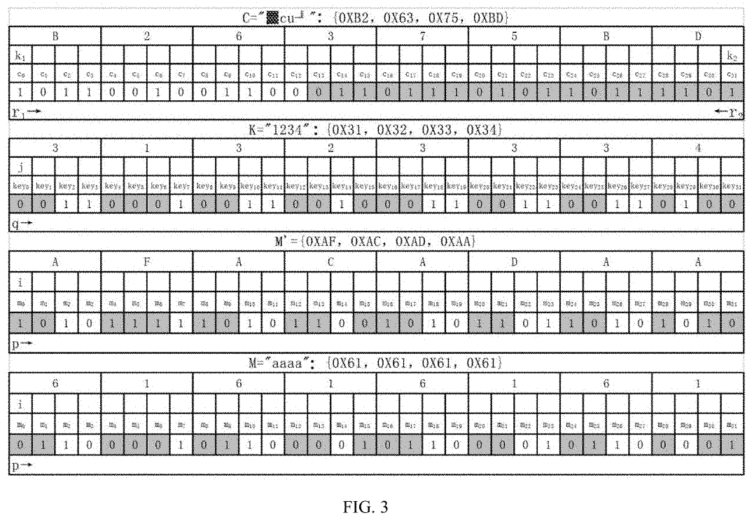

A decryption hash function is an inverse operation of an encryption hash function. By scanning a key space and a ciphertext space, a storage address of each binary bit of the ciphertext in a plaintext space is calculated, and then mapped to the plaintext space to obtain the plaintext M. A decryption process of the ciphertext obtained in Example 1 in the encryption example above is shown in FIG. 3.

Note:

1. C={“ [symbol] ”} represents the ciphertext, and is an input sequence for decryption. {0XB2, 0X63, 0X75, 0XBD} is an extended ASCII code (a hexadecimal system) of the ciphertext “ [symbol] ”, which is converted into a binary system to obtain {10110010, 01100011, 01110101, 10111101}.

2. K={“1234”} represents the key. {0X31, 0X32, 0X33, 0X34} is an ASCII code of the key “1234”, which is converted into a binary system to obtain {00110001, 00110010, 00110011, 00110100}.

3. M′ represents a pseudo-plaintext sequence obtained from the ciphertext C after being mapped according to the decryption hash function. {0XAF, 0XAC, 0XAD, 0XAA} is an extended ASCII code (a hexadecimal system) of M′, which is converted into a binary system to obtain {10101111, 10101100, 10101101, 10101010}.

4. M={“aaaa”} represents a plaintext, and is a decrypted output sequence. {0X61, 0X61, 0X61, 0X61} is an ASCII code (a hexadecimal system) of the plaintext “aaaa”, which is converted into a binary system to obtain {01100001, 01100001, 01100001, 01100001}.

5. The ciphertext, the key, and the plaintext all use a logical structure of a round-robin queue, which may be calculated at any position in the queue, and initial values are now taken as i=0, j=0, k₁=0, and k₂=31. A working pointer p points to a plaintext M[0], q points to a key K[0], and r₁ and r₂ point to ciphertexts C[0] and C[31]. A decryption process is shown in FIG. 3.

6. According to a value of a binary bit of the key K, a hash function deHash of the decryption algorithm is applied to obtain a binary bit r₁ of the ciphertext corresponding to a binary bit q of a “true” value of the key, wherein the binary bit of the ciphertext is negated and then mapped to a plaintext space p, and is filled from left to right; and a binary bit r₂ of the ciphertext corresponding to a binary bit q of a “false” value of the key, wherein the binary bit of the ciphertext is negated and then mapped to a plaintext space p, and is filled from right to left.

7. Gray shading parts in the key K represent “false” value parts, and gray shading parts in the ciphertext C represent ciphertexts corresponding to the “false” value parts of the key K. The ciphertext C is mapped according to the decryption hash function to obtain the pseudo-plaintext sequence M′, and partial binary bits of the pseudo-plaintext sequence M′ are negated according to a specific bit (“false” value binary bit) of the key bit by bit to obtain the plaintext M.

### III. Design and Implementation Solution

The implementations of the technical solution of the present invention are described in detail hereinafter, including a total of four parts: 1. design of hash function set, 2. design of bit operation rule set, 3. design of encryption and decryption method set, and 4. specific implementations of encryption and decryption method 1.

1. Design of Hash Function Set

The encryption hash function set E and the decryption hash function set D have the following characteristics.

If E={enHashᵢ( )} and D={deHashⱼ( )}, wherein enHashᵢ( ) is the encryption hash function and deHashⱼ( ) is the decryption hash function, then C=enHashᵢ(M, K), and M=deHashⱼ(C, K), that is: if there is the encryption hash function enHashᵢ( )∈E to allow M^{K}→C, then there must be the corresponding decryption hash function deHashⱼ( )∈D to allow C^{K}→M, which means that the encryption hash function and the decryption hash function are reversible, and there should be a one-to-one correspondence between the encryption function and the decryption function.

1.1 Encryption and Decryption Hash Functions 1 (Based on Scanning of Plaintext in One Pass)

When a hash address is calculated, a phenomenon that a same address is obtained from different keywords through a same hash function is called a conflict or a collision, which means that keyₓ≠key_{y}, but H(keyₓ)=H(key_{y}). There are many methods to construct the hash function, wherein a dynamic direct addressing method proposed herein is not a compressed mapping method, and an address set and a keyword set have a same size. Therefore, there is no conflict between different keywords, the method has a strong anti-collision performance, and the hash function itself is simple, efficient and easy to implement, thus being very suitable for the algorithm.

Each binary triple group (mᵢ, keyⱼ, cₖ) is composed of the plaintext, the key, and the ciphertext, wherein mᵢ, keyⱼ, cₖ∈{0,1}, i, k∈[0,8*len(M)−1], and j∈[0,8*len(K)−1].

(1) Encryption hash function 1: a hash function for calculating a storage address k of a binary bit mᵢ of the plaintext numbered as i in the plaintext space C is designed as follows:

$$enHash ( {m}_{i} ) = k \{ \begin{matrix}when {key}_{j MOD ( 8 * len ( K ) )} = 1 , & k = {k}_{1} \\ when {key}_{j MOD ( 8 * len ( K ) )} = 0 , & k = {k}_{2}\end{matrix} \qquad ( formula 2 )$$

wherein initial values of k₁ and k₂ meet: k₂=(k₁+8*len(C)−1) MOD (8*len(C))

The plaintext and the key are scanned at the same time according to binary bits in one pass, and len(M) characters need to be scanned:

when key_{j MOD (8*len(K))}=1:

$$enHash ( {m}_{i} ) = {k}_{1} , {k}_{1} = ( {k}_{1} + 1 ) MOD ( {8}^{*} len ( C ) ) , i = ( i + 1 ) MOD ( {8}^{*} len ( M ) ) , j = ( j + 1 ) MOD ( {8}^{*} len ( K ) ) \qquad$$

when key_{j MOD (8*len(K))}=0:

$$enHash ( {m}_{i} ) = {k}_{2} , {k}_{2} = ( {k}_{2} - 1 + {8}^{*} len ( C ) ) MOD ( {8}^{*} len ( C ) ) , i = ( i + 1 ) MOD ( {8}^{*} len ( M ) ) , j = ( j + 1 ) MOD ( {8}^{*} len ( K ) ) \qquad$$

(2) Decryption hash function 1: a hash function for calculating a storage address i of a binary bit cₖ of the ciphertext numbered as k in the plaintext space M is designed as follows:

$$deHash ( {c}_{k} ) = i \{ \begin{matrix}when {key}_{j MOD ( 8 * len ( K ) )} = 1 , & k = {k}_{1} \\ when {key}_{j MOD ( 8 * len ( K ) )} = 0 , & k = {k}_{2}\end{matrix} \qquad ( formula 3 )$$

wherein initial values of k₁ and k₂ are the same in encryption, and need to meet: k₂=(k₁+8*len(C)−1) MOD (8*len(C))

The key and the ciphertext are scanned at the same time according to binary bits in one pass, and len(M) characters need to be scanned:

when key_{j MOD (8*len(K))=}1:

$$deHash ( {c}_{k 1} ) = i , i = ( i + 1 ) MOD ( 8 * len ( M ) ) , j = ( j + 1 ) MOD ( 8 * len ( K ) ) , {k}_{1} = ( {k}_{1} + 1 ) MOD ( 8 * len ( C ) )$$

when key_{j MOD (8*len(K))}=0:

$$deHash ( {c}_{k 2} ) = i , i = ( i + 1 ) MOD ( 8 * len ( M ) ) , j = ( j + 1 ) MOD ( 8 * len ( K ) ) , {k}_{2} = ( {k}_{2} - 1 + 8 * len ( c ) ) MOD len ( C )$$

1.2 Encryption and Decryption Hash Functions 2 (Based on Scanning of Plaintext in Two Passes)

Encryption hash function 2: a hash function for calculating a storage address k of a binary bit mᵢ of the plaintext numbered as i in the ciphertext space C is designed as follows:

$$\begin{matrix}{enHash}_{1} ( {m}_{i} ) = k scanning in first pass , when {key}_{j MOD ( 8 * len ( K ) )} = 1 & ( formula 4 ) \\ {enHash}_{2} ( {m}_{i} ) = k scanning in second pass , when {key}_{j MOD ( 8 * len ( K ) )} = 0 & ( formula 5 )\end{matrix}$$

(1) Implementation method 1: based on scanning of the plaintext in two passes, working pointers of the plaintext and the key move backwardly at the same time.

The plaintext and the key are scanned at the same time according to binary bits in a first pass, and len(M) characters need to be scanned:

when key_{j MOD (8*len(K))}=1:

$$enHash ( {m}_{i} ) = k , i = ( i + 1 ) MOD ( 8 * len ( M ) ) , j = ( j + 1 ) MOD ( 8 * len ( K ) ) , k = ( k + 1 ) MOD ( 8 * len ( C ) )$$

when key_{j MOD (8*len(K))}=0:

$$i = ( i + 1 ) MOD ( 8 * len ( M ) ) , j = ( j + 1 ) MOD ( 8 * len ( K ) )$$

The plaintext and the key are scanned at the same time according to binary bits in a second pass, and len(M) characters need to be scanned:

when key_{j MOD (8*len(K))}=0:

$$enHash ( {m}_{i} ) = k , i = ( i + 1 ) MOD ( 8 * len ( M ) ) , j = ( j + 1 ) MOD ( 8 * len ( K ) ) , k = ( k + 1 ) MOD ( 8 * len ( C ) )$$

when key_{j MOD (8*len(K))}=1:

$$i = ( i + 1 ) MOD ( {8}^{*} len ( M ) ) , j = ( j + 1 ) MOD ( {8}^{*} len ( K ) )$$

(2) Implementation method 2: based on scanning of the plaintext in two passes, working pointers of the key and the ciphertext move backwardly at the same time.

The plaintext and the key are scanned at the same time according to binary bits in a first pass, and len(M) characters need to be scanned:

when key_{j MOD (8*len(K))}=1:

$$enHash ( {m}_{i} ) = k , i = ( i + 1 ) MOD ( {8}^{*} len ( M ) ) , j = ( j + 1 ) MOD ( {8}^{*} len ( K ) ) , k = ( k + 1 ) MOD ( {8}^{*} len ( C ) ) \qquad$$

when key_{j MOD (8*len(K))}0:

$$j = ( j + 1 ) MOD ( {8}^{*} len ( K ) ) , k = ( k + 1 ) MOD ( {8}^{*} len ( C ) ) \qquad$$

The plaintext and the key are scanned at the same time according to binary bits in a second pass, and len(M) characters need to be scanned:

when key_{j MOD (8*len(K))}0:

$$enHash ( {m}_{i} ) = k , i = ( i + 1 ) MOD ( {8}^{*} len ( M ) ) , j = ( j + 1 ) MOD ( {8}^{*} len ( K ) ) , k = ( k + 1 ) MOD ( {8}^{*} len ( C ) ) \qquad$$

when key_{j MOD (8*len(K))}=1:

$$j = ( j + 1 ) MOD ( {8}^{*} len ( K ) ) , k = ( k + 1 ) MOD ( {8}^{*} len ( C ) ) \qquad$$

Decryption hash function 2: a hash function for calculating a storage address i of a binary bit cₖ of the ciphertext numbered as k in the plaintext space M is designed as follows:

$$\begin{matrix}{deHash}_{1} ( {c}_{k} ) = i scanning in first pass , when {key}_{j MOD ( 8 * len ( K ) )} = 1 & ( formula 6 ) \\ {deHash}_{2} ( {c}_{k} ) = i scanning in second pass , when {key}_{j MOD ( 8 * len ( K ) )} = 0 & ( formula 7 )\end{matrix}$$

(1) Implementation method 1: based on scanning of the plaintext in two passes, working pointers of the plaintext and the key move backwardly at the same time.

The key and the ciphertext are scanned at the same time according to binary bits in a first pass, and len(M) characters need to be scanned:

when key_{j MOD (8*len(K))}=1:

$$deHash ( {c}_{k} ) = i , i = ( i + 1 ) MOD ( {8}^{*} len ( M ) ) , j = ( j + 1 ) MOD ( {8}^{*} len ( K ) ) , k = ( k + 1 ) MOD ( {8}^{*} len ( C ) ) \qquad$$

when key_{j MOD (8*len(K))}=0:

$$i = ( i + 1 ) MOD ( {8}^{*} len ( M ) ) , k = ( k + 1 ) MOD ( {8}^{*} len ( C ) ) \qquad$$

The key and the ciphertext are scanned at the same time according to binary bits in a second pass, and len(M) characters need to be scanned:

when key_{j MOD (8*len(K))}0:

$$deHash ( {c}_{k} ) = i , i = ( i + 1 ) MOD ( {8}^{*} len ( M ) ) , j = ( j + 1 ) MOD ( {8}^{*} len ( K ) ) , k = ( k + 1 ) MOD ( {8}^{*} len ( C ) ) \qquad$$

when key_{j MOD (8*len(K))}=1:

$$i = ( i + 1 ) MOD ( {8}^{*} len ( M ) ) , k = ( k + 1 ) MOD ( {8}^{*} len ( C ) ) \qquad$$

(2) Implementation method 2: based on scanning of the plaintext in two passes, working pointers of the key and the ciphertext move backwardly at the same time.

The key and the ciphertext are scanned at the same time according to binary bits in a first pass, and len(M) characters need to be scanned:

when key_{j MOD (8*len(K))}=1:

$$deHash ( {c}_{k} ) = i , i = ( i + 1 ) MOD ( {8}^{*} len ( M ) ) , j = ( j + 1 ) MOD ( {8}^{*} len ( K ) ) , k = ( k + 1 ) MOD ( {8}^{*} len ( C ) ) \qquad$$

when key_{j MOD (8*len(K))}=0:

$$j = ( j + 1 ) MOD ( {8}^{*} len ( K ) ) , k = ( k + 1 ) MOD ( {8}^{*} len ( C ) ) \qquad$$

The key and the ciphertext are scanned at the same time according to binary bits in a second pass, and len(M) characters need to be scanned:

when key_{j MOD (8*len(K))}=0:

$$deHash ( {c}_{k} ) = i , i = ( i + 1 ) MOD ( {8}^{*} len ( M ) ) , j = ( j + 1 ) MOD ( {8}^{*} len ( K ) ) , k = ( k + 1 ) MOD ( {8}^{*} len ( C ) ) \qquad$$

when key_{j MOD (8*len(K))}=1:

$$j = ( j + 1 ) MOD ( {8}^{*} len ( K ) ) , k = ( k + 1 ) MOD ( {8}^{*} len ( C ) ) \qquad$$

2. Design of Bit Operation Rule Set

A problem of too many 0 or 1 (i.e., too many bytes like 0X00 or 0XFF) in binary coding of the plaintext and the key, which leads to a problem of encryption failure or easy decryption, can be solved by negating partial or all binary bits of the plaintext and the key. Bit operation rules may be designed by means of a mathematical formula, by means of a pseudo-random sequence and various chaotic signals generated by various key stream generators, or by means of a random file with uniform code distribution on a binary system. Abstract description of the bit operation rules is as follows.

Rule 1: according to a true value bit or a false value bit of the key stream, negating partial binary bits of the plaintext.

Rule 2: according to various Boolean functions, negating partial binary bits of the plaintext.

Rule 3: according to a true value bit or a false value bit of another key stream, negating partial binary bits of an initial key stream.

Rule 4: according to various Boolean functions, negating partial binary bits of the initial key stream.

According to the abstract rules described above, several specific bit operation rules are listed below:

(1) with reference to the hash function designed above, negating partial binary bits of the plaintext corresponding to “false” value bits of the key;

(2) with reference to the hash function designed above, negating partial binary bits of the plaintext corresponding to “true” value bits of the key;

(3) negating odd bits of the plaintext;

(4) negating even bits of the plaintext;

(5) negating odd bits of the key; and

(6) negating even bits of the key.

Note:

(1) In specific rules 1 and 2, according to a true value bit or a false value bit of the key stream, partial binary bits of the plaintext are negated.

(2) In specific rules 3, 4, 5, and 6, if a specific bit meeting a formula of |C+X×i| MOD Y=Z is negated in a traversing process, wherein i is a serial number of the binary bit, C and X are integers, Y is a positive integer, and Z is an integer greater than or equal to 0 and less than Y, the specific bit may be an odd bit, an even bit, and a binary bit with a remainder being zero when divided by a certain prime number Y.

(3) The above binary bit operation rules of the plaintext and the key may also sometimes be used at the same time.

3. Design of Encryption and Decryption Method Set

The encryption and decryption method set is designed on the basis a combination of a hash function set and a bit operation rule set, and combination methods are flexible and diverse. Now only five encryption and decryption methods are enumerated.

TABLE 1
Table of (partial) encryption and decryption methods

| | Technical feature | | | | | | | |
|---|---|---|---|---|---|---|---|---|
| | Feature of | | | | | | | |
| | hash function | | | | | | | |
| | 1: double | | | | | | | |
| | working | Feature of | Feature of | | | | | |
| | pointers are | hash function | hash function | | | | | |
| | provided for | 2.1: working | 2.2: working | | | | | |
| | the ciphertext | pointers of the | pointers of the | Specific | Specific | Specific | Specific | Specific |
| | and move in | plaintext and | ciphertext and | bit | bit | bit | bit | bit |
| Method | an opposite | the ciphertext | the key move | operation | operation | operation | operation | operation |
| name | directions | move together | together | rule 1 | rule 2 | rule 3 | rule 4 | rule 5 |
| Encryption and | √ | | | √ | | | | |
| decryption | | | | | | | | |
| method 1 | | | | | | | | |
| Encryption and | √ | | | | √ | | | |
| decryption | | | | | | | | |
| method 2 | | | | | | | | |
| Encryption and | √ | | | √ | | | | √ |
| decryption | | | | | | | | |
| method 3 | | | | | | | | |
| Encryption and | | √ | | | | √ | | |
| decryption | | | | | | | | |
| method 4 | | | | | | | | |
| Encryption and | | | √ | | | | √ | |
| decryption | | | | | | | | |
| method 5 | | | | | | | | |

3.1 Encryption and Decryption Method 1

Based on designs of the encryption and decryption hash function 1 and the bit operation rule 1, the plaintext is traversed in one pass, the ciphertext is written bidirectionally, and the plaintext corresponding to the “false” bit of the key is negated.

1. Encryption Method 1

A simple and practicable encryption solution is as follows.

Firstly, according to a value of a binary bit key of the key, a storage address k of a binary bit mⱼ of the plaintext numbered as i in the ciphertext space C is calculated by the encryption hash function described above.

Then, whether a true value of the plaintext mᵢ is changed by the bit operation is determined according to the value of the key keyⱼ. In the solution, mᵢ corresponding to key with all values being 0 is negated to become mᵢ′, while a value of mᵢ corresponding to keyⱼ with all values being 1 remains unchanged.

Finally, the obtained mᵢ′, or mᵢ is mapped to the storage address k of the ciphertext space C to obtain a ciphertext cₖ.

The encryption algorithm 1 is described as follows.

In step 1, initial values i, j, k₁ and k₂ are taken, which meet 0≤i≤8*len(M)−1, 0≤j≤8*len(M)−1, 0≤k₁ and k₂≤8*len(K)−1, and k₂=(k₁+8*len(C)−1)%(8*len(C)), and are saved.

In step 2, bit working pointers p and q are taken and respectively used to traverse the plaintext and key storage spaces, and bit working pointers r and s are used to traverse the ciphertext space, wherein the r pointer moves from left to right, and the s pointer moves from right to left. According to the initial values, p→mᵢ, q→keyⱼ, r→cₖ₁, and s→cₖ₂ are allowed.

In step 3, the plaintext and the key are traversed in one pass, and the ciphertext is generated in a traversing process. An encryption process is divided into two cases according to the value of the binary bit of the key by the encryption hash function enHash described above.

(1) When a value of a current binary bit (*q) of the key is 1, *r=*p, p++, q++, and r++.

(2) When the value of the current binary bit (*q) of the key is 0, *s=(*p+1)MOD 2, q++, p++, and s−−.

Encryption is completed.

2. Decryption Method 1

Firstly, according to a value of a binary bit key of the key, a storage address i of a binary bit cₖ of the ciphertext numbered as k in the ciphertext space C is calculated by the decryption hash function described above.

Then, whether a true value of the ciphertext cₖ is restored by the bit operation is determined according to the value of the key keyⱼ. In the solution, cₖ corresponding to key with all values being 0 is negated to become cₖ′, while a value of cₖ corresponding to keyⱼ with all values being 1 remains unchanged.

Finally, the obtained cₖ′ or cₖ is mapped to the storage address i of the plaintext space M to obtain the plaintext mᵢ.

The decryption algorithm 1 is described as follows.

In step 1, the initial values i, j, k₁, and k₂ are taken back.

In step 2, bit working pointers p, q, r, and s are taken. According to the initial values, p→mᵢ, q→keyⱼ, r→cₖ₁, and s→cₖ₂ are allowed.

In step 3, the ciphertext and the key are traversed in one pass, the plaintext is decrypted in a traversing process, and a decryption process is divided into two cases according to the value of the binary bit of the key by the decryption hash function deHash described above.

(1) When a value of a current binary bit (*q) of the key is 1, *p=*r, p++, q++, and r++.

(2) When the value of the current binary bit (*q) of the key is 0, *p=(*s+1)MOD 2, q++, p++, and s−−.

Decryption is completed.

Note:

(1) A logical structure of the plaintext, the key, and the ciphertext is a round-robin queue, and the working pointers move on the round-robin queue, which means that m_{8*len(M)-1} is followed by m₀, k_{8*len(K)-1} is followed by k₀, and c_{8*len(C)-1} is followed by c₀.

(2) i, j, k₁, and k₂ correspond to the working pointers p, q, r, and s, and move with the working pointers.

3.2 Design of Encryption and Decryption Method 2

Based on designs of the encryption and decryption hash function 1 and the bit operation rule 2, the plaintext is traversed in one pass, the ciphertext is written bidirectionally, and the plaintext corresponding to the “true” bit of the key is negated. An encryption process of the method 2 differs from an encryption process of the method 1 in a bit operation part of step 3. In the encryption process, according to the algorithm 2, the value of mᵢ corresponding to key with all values being 0 remains unchanged, while mᵢ corresponding to keyⱼ with all values being 1 is negated to become mᵢ′. In the decryption process, according to the method 2, the value of cₖ corresponding to keyⱼ with all values being 0 remains unchanged, while cₖ corresponding to key with all values being 1 is negated to become cₖ′.

1. Encryption Algorithm 2

In step 1, initial values i, j, k₁ and k₂ are taken, which meet 0≤i≤8*len(M)−1, 0≤j≤8*len(M)−1, 0≤k₁ and k₂≤8*len(K)−1, and k₂=(k₁+8*len(C)−1)%(8*len(C)), and are saved.

In step 2, bit working pointers p and q are respectively used to traverse the plaintext and key storage spaces, and bit working pointers r and s are used to traverse the ciphertext space, wherein the r pointer moves from left to right, and the s pointer moves from right to left. According to the initial values, p→mᵢ, q→keyⱼ, r→cₖ₁, and s→cₖ₂ are allowed.

In step 3, the plaintext and the key are traversed in one pass, and the ciphertext is generated in a traversing process. An encryption process is divided into two cases according to the value of the binary bit of the key by the encryption hash function enHash described above.

(1) When a value of a current binary bit (*q) of the key is 1, *r=(*p+1) MOD 2, p++, q++, and r++.

(2) When the value of the current binary bit (*q) of the key is 0, *s=*p, q++, p++, and s−−.

2. Decryption Algorithm 2

In step 1, the initial values i, j, k₁, and k₂ are taken back.

In step 2, the bit working pointers p, q, r, and s are taken. According to the initial values, p→mᵢ, q→keyⱼ, r→cₖ₁, and s→cₖ₂ are allowed.

In step 3, the ciphertext and the key are traversed in one pass, the plaintext is decrypted in a traversing process, and a decryption process is divided into two cases according to the value of the binary bit of the key by the decryption hash function deHash described above.

(1) When a value of a current binary bit (*q) of the key is 1, *p=(*r+1) MOD 2, p++, q++, and r++.

(2) When the value of the current binary bit (*q) of the key is 0, *p=*s, q++, p++, and s−−.

Note:

(1) A logical structure of the plaintext, the key, and the ciphertext is a round-robin queue, and the working pointers move on the round-robin queue, which means that m_{8*len(M)-1} is followed by m₀, k_{8*len(K)-1} is followed by k₀, and c_{8*len(C)-1} is followed by c₀.

(2) i, j, k₁, and k₂ correspond to the working pointers p, q, r, and s, and move with the working pointers.

3.3 Design of Encryption and Decryption Method 3

Based on designs of the encryption and decryption hash function 1, the bit operation rule 1, and the bit operation rule 5, the plaintext and the key are traversed in one pass, the ciphertext is written unidirectionally, the working pointers of the plaintext and the key move backwardly at the same time, the odd bits of the key are negated, and the plaintext corresponding to the “false” bit of the key is negated.

The encryption algorithm 3 is described as follows.

In step 1, initial values i, j, k₁ and k₂ are taken, which meet 0≤i≤8*len(M)−1, 0≤j≤8*len(M)−1, 0≤k₁ and k₂≤8*len(K)−1, and k₂=(k₁+8*len(C)−1)%(8*len(C)), and are saved.

In step 2, bit working pointers p and q are taken and respectively used to traverse the plaintext and key storage spaces, and bit working pointers r and s are used to traverse the ciphertext space, wherein the r pointer moves from left to right, and the s pointer moves from right to left. According to the initial values, p→mᵢ, q→keyⱼ, r→cₖ₁, and s→cₖ₂ are allowed.

The plaintext and the key are traversed in one pass in step 3, and if the key is the odd bit, which means that j MOD 2 is 1, then *q=(*q+1)MOD 2.

(1) When a value of a current binary bit (*q) of the key is “true”, *r=*p, p++, q++, and r++.

(2) When the value of the current binary bit (*q) of the key is “false”, *s=(*p+1)MOD 2, q++, p++, and s−−.

Encryption is completed.

The decryption algorithm 3 is described as follows.

In step 1, the initial values i, j, and k are taken back.

In step 1, the initial values i, j, k₁, and k₂ are taken back.

In step 2, bit working pointers p, q, r, and s are taken. According to the initial values, p→mᵢ, q→keyⱼ, r→cₖ₁, and s→cₖ₂ are allowed.

In step 3, the ciphertext and the key are traversed in one pass.

(1) When a value of a current binary bit (*q) of the key is “true”, *p=*r, p++, q++, and r++.

(2) When the value of the current binary bit (*q) of the key is “false”, *p=(*s+1)MOD 2, q++, p++, and s−−.

Decryption is completed.

Note:

(1) A logical structure of the plaintext, the key, and the ciphertext is a round-robin queue, and the working pointers move on the round-robin queue, which means that m_{8*len(M-1} is followed by m₀, k_{8*len(K)-1} is followed by k₀, and c_{8*len(C)-1} is followed by c₀.

(2) i, j, k₁, and k₂ correspond to the working pointers p, q, r, and s, and move with the working pointers.

3.4 Design of Encryption and Decryption Method 4

Based on designs of the encryption and decryption hash function 2 (implementation method 1) and the bit operation rule 3, the plaintext is traversed in two passes, the ciphertext is written unidirectionally, the working pointers of the plaintext and the key move backwardly at the same time, and the odd bits of the plaintext are negated.

The encryption algorithm 4 is described as follows.

In step 1, the initial values i, j, and k are taken, which meet 0≤i≤8len(M)−1, 0≤j≤8len(M)−1, and 0≤k≤8len(K)−1, and are saved.

In step 2, bit pointer variables p, q, and r are taken and respectively used to traverse the plaintext, key, and ciphertext spaces respectively. According to the initial values, p→mᵢ, q→keyⱼ, and r→cₖ are allowed.

In step 3, in first traversal, when *q is true:

(1) if the plaintext is the odd bit, which means that i MOD 2 is 1, then *r=(*p+1) MOD 2, p++, q++, and r++;

(2) otherwise, the plaintext is the even bit, then *r=*p, p++, q++, and r++;

otherwise, *q is false, then p++and q++.

In step 4, initial bits of the pointers are restored.

In step 5, in second traversal, when *q is false:

(1) if the plaintext is the odd bit, which means that i MOD 2 is 1, then *r=(*p+1) MOD 2, p++, q++, and r++;

(2) otherwise, the plaintext is the even bit, then *r=*p, p++, q++, and r++;

otherwise, *q is true, then p++and q++.

Encryption is completed.

The decryption algorithm 4 is described as follows.

In step 1, the initial values i, j, and k are taken back.

In step 2, bit pointer variables p, q, and r are taken. According to the initial values, p→mᵢ, q→keyⱼ, and r→cₖ are allowed.

In step 3, in first traversal, when *q is true:

(1) if the plaintext is the odd bit, which means that i MOD 2 is 1, then *p=(*r+1) MOD 2, p++, q++, and r++;

(2) otherwise, the plaintext is the even bit, then *p=*r, p++, q++, and r++;

otherwise, *q is false, then p++ and q++.

In step 4, initial bits of the pointers are restored.

In step 5, in second traversal, when *q is false:

(1) if the plaintext is the odd bit, which means that i MOD 2 is 1, then *p=(*r+1) MOD 2, p++, q++, and r++;

(2) otherwise, the plaintext is the even bit, then *p=*r, p++, q++, and r++;

otherwise, *q is true, then p++and q++.

Decryption is completed.

Note:

(1) A logical structure of the plaintext, the key, and the ciphertext is a round-robin queue, and the working pointers move on the round-robin queue, which means that m_{8*len(M)-1} is followed by m₀, k_{8*len(K)-1} is followed by k₀, and c_{8*len(C)-1} is followed by c₀.

(2) i, j, k₁, and k₂ correspond to the working pointers p, q, r, and s, and move with the working pointers.

3.5 Design of Encryption and Decryption Method 5

Based on designs of the encryption and decryption hash function 2 (implementation method 2) and the bit operation rule 4, the plaintext is traversed in two passes, the ciphertext is written unidirectionally, the working pointers of the key and the ciphertext move backwardly at the same time, and the even bits of the plaintext are negated.

The encryption algorithm 5 is described as follows.

In step 1, the initial values i, j, and k are taken, which meet 0≤i≤8len(M)−1, 0≤8len(M)−1, and 0≤k≤8len(K)−1, and are saved.

In step 2, bit pointer variables p, q, and r are taken and respectively used to traverse the plaintext, key, and ciphertext spaces respectively. According to the initial values, p→mᵢ, q→keyⱼ, and r→cₖ are allowed.

In step 3, in first traversal, when *q is true:

(1) if the plaintext is the even bit, which means that i MOD 2 is 0, then *r=(*p+1) MOD 2, p++, q++, and r++;

(2) otherwise, the plaintext is the odd bit, then *r=*p, p++, q++, and r++;

otherwise, *q is false, then q++, and r++.

In step 4, initial bits of the pointers are restored.

In step 5, in second traversal, when *q is false:

(1) if the plaintext is the even bit, which means that i MOD 2 is 0, then *r=(*p+1) MOD 2, p++, q++, and r++;

(2) otherwise, the plaintext is the odd bit, then *r=*p, p++, q++, and r++;

otherwise, *q is true, then q++, and r++.

Encryption is completed.

The decryption algorithm 5 is described as follows.

In step 1, the initial values i, j, and k are taken back.

In step 2, bit pointer variables p, q, and r are taken. According to the initial values, p→mᵢ, q→keyⱼ, and r→cₖ are allowed.

In step 3, in first traversal, when *q is true:

(1) if the plaintext is the even bit, which means that i MOD 2 is 0, then *p=(*r+1) MOD 2, p++, q++, and r++;

(2) otherwise, the plaintext is the odd bit, then *p=*r, p++, q++, and r++;

otherwise, *q is false, then q++, and r++.

In step 4, initial bits of the pointers are restored.

In step 5, in second traversal, when *q is false:

(1) if the plaintext is the even bit, which means that i MOD 2 is 0, then *p=(*r+1) MOD 2, p++, q++, and r++;

(2) otherwise, the plaintext is the odd bit, then *p=*r, p++, q++, and r++;

otherwise, *q is false, then q++, and r++.

Decryption is completed.

Note:

(1) A logical structure of the plaintext, the key, and the ciphertext is a round-robin queue, and the working pointers move on the round-robin queue, which means that m_{8*len(M)-1} is followed by m₀, k_{8*len(K)-1} is followed by k₀, and c_{8*len(C)-}1 is followed by c₀.

(2) i, j, k₁, and k₂ correspond to the working pointers p, q, r, and s, and move with the working pointers.

4. Specific Algorithm Implementation of Encryption and Decryption Method

The encryption and decryption method set is designed on the basis a combination of a hash function set and a bit operation rule set, five encryption and decryption methods are described above, and now the method 1 is taken as an example to illustrate a specific implementation process of the encryption and decryption method.

4.1 Encryption Algorithm Implementation Process

1. The plaintext file and the key file in Example 1 are read in.

Plaintext “aaaa”={0X61, 0X61, 0X61, 0X61}₁₆={01100001, 01100001, 01100001, 01100001}₂.

Key “1234”={0X31, 0X32, 0X33, 0X34}₁₆={00110001, 00110010, 00110011, 00110100}₂.

2. A character pointer is established

dynamic pointer of plaintext string array: char *M;

dynamic pointer of key string array: char *K;

dynamic pointer of ciphertext string array: char *C.

3. The plaintext file M is opened, and a number of bytes of the plaintext file M is counted and stored in M bytes.

4. A storage space is allocated

plaintext storage space M=new char[M_bytes+1];

key storage space K=new char[M bytes+1];

ciphertext storage space C=new char[M_bytes+1].

5. Initial values of bit subscripts are taken

Both initial values i and j of the bit subscripts are taken to be 0, which means that the encryption starts from first binary bits of the plaintext and the key, and the initial values of the bit subscripts are taken to be k₁=0 and k₂₌₃₁ respectively, which means that k₁ and k₂ respectively point to a low address end and a high address end of the ciphertext, with reference to FIG. 1.

Note: in a practical application, the initial values of the subscripts may be any legal values in an array space.

6. Contents of the plaintext file are read into a storage space pointed by an array M. Moreover, a working pointer M_head points to a byte where i=0 is located. When the working pointer M_head points to the string tail mark, if encryption circulation is still not finished, the pointer M_head points to a first byte of the string.

7. Contents of the key file are read into a storage space pointed by K. Moreover, a working pointer K_head points to a byte where j=0 is located. When the working pointer K_head points to the string tail mark, if encryption circulation is still not finished, the pointer K_head points to a first byte of the string.

Note: in a practical application, the plaintext, the key, and the ciphertext are all implemented by a structure similar to the round-robin queue. A length of the key file is not necessarily equal to a length of the plaintext file. If the key file is long, then M_bytes bytes are intercepted as the key, and if the key file is short, then a circular key is used.

8. The working pointer C_head of the ciphertext points to a position of k₁=0. The working pointer C_tail of the ciphertext points to a position of k₁=31, and C_head and C_tail move in an opposite direction. When the pointer C_head points to the string tail mark, if encryption circulation is still not finished, then the pointer C_head points to a first byte of the string. When the pointer C_tail points to the first byte of the string, if encryption circulation is still not finished, then the pointer C_tail points to a tail of the string.

9. A function int read_bit(char *p_str,int n) is established

function parameter: p_str is a pointer pointing to the character string, and the parameter n represents a binary bit with a subscript n;

function effect: values (0, 1) of the n^{th} bit in the character string pointed by p are found and returned;

function return value: values (0, 1) of the n^{th} bit in the character string pointed by p are returned.

10. A function void write_bit_1(char *p_str,int n) is established

function parameter: p_str is a pointer pointing to the character string, and the parameter n represents a binary bit with a subscript n;

function effect: 1 is written in the n^{th} bit in the character string pointed by p_str;

function return value: null;

sequence of key statement:

```
char ch;
int byte=n/8, bit=n%8;
p_str+=byte;
ch=*p_str;
switch(bit){
  case 0:{ch=ch|0x80; break;}
  case 1:{ch=ch|0x40; break;}
  case 2:{ch=ch|0x20; break;}
  case 3:{ch=ch|0x10; break;}
  case 4:{ch=ch|0x08; break;}
  case 5:{ch=ch|0x04; break;}
  case 6:{ch=ch|0x02; break;}
  case 7:{ch=ch|0x01; break;}
}
*p_str=ch;
```

11. A function void write_bit_0 (char *p_str,int n) is established

function parameter: p_str is a pointer pointing to the character string, and the parameter n represents a binary bit with a subscript n;

function effect: 0 is written in the n^{th} bit in the character string pointed by p_str;

function return value: null;

sequence of key statement:

```
char ch;
int byte=n/8, bit=n%8;
p_str+=byte;
ch=*p_str;
switch(bit){
  case 0:{ch=ch&0x7f; break;}
  case 1:{ch=ch&0xbf; break;}
  case 2:{ch=ch&0xdf; break;}
  case 3:{ch=ch&0xef; break;}
  case 4:{ch=ch&0xf7; break;}
  case 5:{ch=ch&0xfb; break;}
  case 6:{ch=ch&0xfd; break;}
  case 7:{ch=ch&0xfe; break;}
}
*p_str=ch;
```

12. A function void encrypt( ) is established

function parameter: none;

function effect: the plaintext M and the key K are traversed in one pass, the ciphertext space C is traversed bidirectionally, and the ciphertext generated after encryption is stored in C;

function return value: null

sequence of key statement:

```
C_head=0;
C_tail=8*M_bytes−1;
K_head=0;
M_head=0;
for(; K_head<8* M_bytes; K_head++){
  if(1 == read_bit(K, K_head)){
    if(1 == read_bit(M, M_head++))
      write_bit_1(C, C_head++);
    else
      write_bit_0(C, C_head++);
  }
  else{
    if(1 == read_bit(M, M_head++))
      write_bit_0(C, C_tail−−);
    else
      write_bit_1(C, C_tail−−);
  }
}
```

13. The ciphertext array C obtained by calculating an encrypt ( ) function is written into the ciphertext file and saved to obtain a ciphertext file “ [symbol] ”, which is namely {0XB2, 0X63, 0X75, 0XBD}₁₆={10110010, 01100011, 01110101, 10111101}₂.

14. A function void statistical Analysis( ) is established

function parameter: none;

function effect: times of appearance of each character code (in bytes) are counted, and then a code uniformity is calculated;

function return value: null.

sequence of key statement:

```
int radix=256;
double lambda=0, max_lam=0;
for(int i=0; i<M_bytes; i++){
  ascii[C[i]&0x000000ff]++;
}
for(int i=0; i<radix; i++){
  lambda+=pow(ascii[i]−(M_bytes*1.0/radix), 2);
}
max_lam+=pow(M_bytes−(M_bytes*1.0/radix), 2);
for(int i=0; i<radix−1; i++){
  max_lam+=pow(0−(M_bytes*1.0/radix), 2);
}
```

If calculated in bytes, a total number of different symbols (codes) radix is 256, lambda is a code uniformity of a ciphertext obtained through calculation by the present method, and max_lam is a maximum value of the code uniformity.

4.2 Decryption Algorithm Implementation Process

1. “ [symbol] ” is saved in the ciphertext file C

which is namely {0XB2, 0X63, 0X75, 0XBD}₁₆={10110010, 01100011, 01110101, 10111101}₂.

“1234” is saved in the key file K

which is namely {0X31, 0X32, 0X33, 0X34}₁₆={00110001, 00110010, 00110011, 00110100}₂.

2. A character pointer is established

dynamic pointer of plaintext string array: char *M_decrypt;

dynamic pointer of key string array: char *K;

dynamic pointer of ciphertext string array: char *C.

3. The ciphertext file C is opened, and a number of bytes of the ciphertext file C is counted and stored in C_bytes.

4. A storage space is allocated

plaintext storage space M_decrypt=new char[C bytes+1];

key storage space K=new char[C_bytes+1];

ciphertext storage space C=new char[C_bytes+1].

5. Initial values of bit subscripts are taken

Both initial values i and j of the bit subscripts are taken to be 0, which means that the encryption starts from first binary bits of the plaintext and the key, and the initial values of the bit subscripts are taken to be k₁=0 and k₂=31 respectively, which means that k₁ and k₂ respectively point to a low address end and a high address end of the ciphertext, with reference to FIG. 2.

Note: in a practical application, the initial values of the subscripts may be any legal values in an array space.

6. Contents of the ciphertext file are read into a storage space pointed by an array C. The working pointer C_head of the ciphertext points to a position of k₁=0. The working pointer C_tail of the ciphertext points to a position of k₁=31, and C_head and C_tail move in an opposite direction. When the pointer C_head points to the string tail mark, if decryption circulation is still not finished, then the pointer C_head points to a first byte of the string. When the pointer C_tail points to the first byte of the string, if decryption circulation is still not finished, then the pointer C_tail points to a tail of the string.

7. Contents of the key file are read into a storage space pointed by K. Moreover, a working pointer K_head points to a byte where j=0 is located. When the working pointer K_head points to the string tail mark, if encryption circulation is still not finished, the pointer K_head points to a first byte of the string.

Note: in a practical application, the plaintext, the key, and the ciphertext are all implemented by a structure similar to the round-robin queue. A length of the key file is not necessarily equal to a length of the ciphertext file. If the key file is long, then C_bytes bytes are intercepted as the key, and if the key file is short, then a circular key is used.

8. The working pointer M_head of the plaintext points to a byte where i=0 is located. When the working pointer M_head points to the string tail mark, if encryption circulation is still not finished, the pointer M_head points to a first byte of the string.

9. A function int read_bit(char *p_str,int n) is established

function parameter: p_str is a pointer pointing to the character string, and the parameter n represents a binary bit with a subscript n;

function effect: values (0, 1) of the n^{th} bit in the character string pointed by p are found and returned;

function return value: values (0, 1) of the n^{th} bit in the character string pointed by p_str are returned.

10. A function void write bit 1(char *p_str,int n) is established

function parameter: p_str is a pointer pointing to the character string, and the parameter n represents a binary bit with a subscript n;

function effect: 1 is written in the n^{th} bit in the character string pointed by p_str;

function return value: null;

sequence of key statement: the same as the void write_bit_1 function in the encryption process, and will not be repeated.

11. A function void write_bit_0(char *p_str,int n) is established

function parameter: p_str is a pointer pointing to the character string, and the parameter n represents a binary bit with a subscript n;

function effect: 0 is written in the n^{th} bit in the character string pointed by p_str;

function return value: null;

sequence of key statement: the same as the void write_bit_0 function in the encryption process, and will not be repeated.

12. A function void decrypt( ) is established

function parameter: none;

function effect: the ciphertext C is bidirectionally traversed in one pass and the key K is unidirectionally traversed in one pass, and the plaintext generated after decryption is stored in M_decrypt;

function return value: null;

sequence of key statement:

```
C_head=0;
C_tail=8*C_bytes−1;
K_head=0;
M_head=0;
for(; K_head<8* C_bytes; K_head++){
  if(1 == read_one_bit(K, K_head)){
    if(1 == read_one_bit(C, C_head++))
      write_one_bit_1(M_decrypt, M_head++);
    else
      write_one_bit_0(M_decrypt, M_head++);
  }
  else{
    if(1 == read_one_bit(C, C_tail−−))
      write_one_bit_0(M_decrypt, M_head++);
    else
      write_one_bit_1(M_decrypt, M_head++);
  }
}
```

13. The plaintext array M decrypt obtained by calculating a decrypt( ) function is written into the plaintext file and saved to obtain a plaintext file “aaaa”, which is namely {0X61, 0X61, 0X61, 0X₆₁}={01100001, 01100001, 01100001, 01100001}₂.

Summarizing the above multiple embodiments, the solution of the present invention is different from the previous traditional stream cipher encryption technology in that the present method does not depend on the bit exclusive-or operation. Main principles are as follows. (1) An existing known coding sequence (which can be called a true random sequence) is used as the key file. The key file may come from an audio, a video, a picture, an image, a graph, a pseudo-random code, and a chaotic value. (2) A reversible hash function set used for encryption and decryption is designed, and then the plaintext is uniformly scattered in a known binary random hash by an encryption hash function. (3) The bit operation rule set is designed, values of all or partial binary bits of a binary random hash are changed by a bit operation, and the values are mapped to the ciphertext space. The encryption method has a strong randomness, and the designs of the hash function set and the bit operation rule set are flexible and diverse. In addition, in the present method, the hash function set is constructed by a dynamic direct addressing method to avoid collision, so that conventional attack techniques to the hash function including a dictionary attack and a birthday attack are invalid.

In addition, there is no byte correspondence between the plaintext set M and the ciphertext set C in the present method, but there is a correspondence in a binary bit, which is based on the hush function generated by the key set K and the bit operation rule. Therefore, in order to decrypt a file encrypted by the present method, four necessary and sufficient conditions must be met: (1) known key set; (2) known decryption hush function set; (3) known bit operation rule set; and (4) known ciphertext file. However, it is impossible to obtain the above four conditions at the same time, and the present method is simple and practicable, and has a high security.

In addition, the technical solution in the previous patent for invention to the applicant in the aspect of stream cipher is only based on a hash function. An existing problem is that in the hash function, only positions of “0” and “1” in the plaintext can be changed and mapped to the ciphertext space. When the code distribution of the plaintext or the key is biased towards all “0” or all “1” in a binary system (that is, when there are too many bytes like 0X00 or 0XFF), there is a situation of encryption failure or being easily attacked. However, introduction of the bit operation rule set in the new method proposed by the present invention can perfectly solve the above situation, so that there is no corresponding relationship between the numbers “0” and “1” in the plaintext and the ciphertext, so that even if a special plaintext is transmitted by the method, the special plaintext is not easy to be decrypted. Moreover, by using the hush function and the bit operation, the code uniformity of the ciphertext is much higher than that of the plaintext, and is also higher than that of traditional stream cipher encryption.

In addition, multi-key encryption may also be used in the present method, the initial ciphertext C is used as a parameter for hashing multiple times to obtain the ciphertext Cⁿ encrypted multiple times, which further improves the security of the algorithm and better meets increasing information encryption requirements. In addition, the key may be kept by different people, which ensures the higher security of the plaintext.

It should be recognized that the method steps in the embodiments of the present invention may be realized or implemented by computer hardware, a combination of hardware and software, or a computer instruction stored in a non-transitory computer readable memory. A standard programming technology may be used in the method. Each program may be implemented by an advanced process or an object-oriented programming language to communicate with a computer system. However, if necessary, the program may be implemented by an assembly or machine language. In any case, the language may be a compiled or interpreted language. In addition, the program may run on a programmed application-specific integrated circuit for this purpose.

In addition, process operations described herein may be performed in any suitable order, unless otherwise indicated herein or otherwise clearly contradicted by context. The processes (or variations and/or combinations) described herein may be executed under the control of one or more computer systems configured with executable instructions, and may be implemented as codes (such as executable instructions, one or more computer programs, or one or more applications) commonly executed on one or more processors by hardware, or a combination thereof. The computer program includes a plurality of instructions executable by one or more processors.

Further, the method may be implemented in any type of suitable computing platform operatively connected, including but not limited to a personal computer, a mini computer, a main framework, a workstation, a network or a distributed computing environment, a separate or integrated computer platform, or communication with a charged particle tool or other imaging devices. All aspects of the present invention may be implemented by a machine-readable code stored in a non-transitory storage medium or device, whether the code is moved or integrated into the computing platform, such as a hard disk, an optical read and/or write storage medium, a RAM, a ROM, and the like, so that the code may be read by a programmable computer. When read by a computer, the storage medium or device may be used to configure and operate the computer to execute the processes described herein. In addition, the machine-readable code, or a part of the machine-readable code may be transmitted through a wired or wireless network. When such medium includes instructions or programs that implement the steps described above in combination with a microprocessor or other data processors, the invention described herein includes these and other different types of non-transitory computer-readable storage media. In a case of programming according to the method and technology of the present invention, the present invention further includes the computer itself.

A computer program can be applied to input data to execute the functions described herein, thus converting the input data to generate output data stored in a nonvolatile memory. Output information may also be applied to one or more output devices such as a display. In a preferred embodiment of the present invention, the converted data represents a physical and tangible object, including a specific visual depiction of the physical and tangible object generated on the display.

The foregoing is only the preferred embodiments of the present invention, and the present invention is not limited to the above embodiments. As long as it achieves the technical effect of the present invention by the same means, it should fall within the scope of protection of the present invention. Any modifications, equivalent substitutions, improvements, and the like made within the gist and principle of the present invention shall be included in the scope of protection of the present invention. The technical solution and/or implementation may have various modifications and changes in the scope of protection of the present invention.

1. An encryption and decryption method based on a random hash and bit operation, comprising the following steps of:
S1: configuring a memory space, and preparing corresponding storage spaces for a plaintext file, a ciphertext file, and a key file, wherein the key file comes from an existing coding sequence and serves as a shared file for encryption and decryption;
S2: providing a reversible hash function set used for encryption and decryption, and then uniformly scattering the plaintext in a known binary random hash by an encryption hash function; and
S3: introducing a bit operation rule set, changing values of all or partial binary bits of the binary random hash by a bit operation, and mapping the values to a ciphertext space.

2. The method of claim 1, wherein the step S1 comprises:
initializing the plaintext file, loading the plaintext file needing to be encrypted, and setting a number of element codes of the key file, wherein a byte length of the key file is customizable, the number of the element codes of the key file is no more than a number of element codes of the plaintext file; and wherein the coding sequence generating the key file comes from at least one of an audio, a video, a picture, an image, a graph, a pseudo-random code, or a chaotic value.

3. The method of claim 1, wherein the step S2 comprises:
constructing the hash function set by a dynamic direct addressing method to avoid collision, so that conventional attack techniques comprising a dictionary attack and a birthday attack are invalid.

4. The method of claim 1, wherein the step S2 comprises: providing an algorithm program of encryption and decryption algorithm program sets to perform displacement reading on the plaintext file, the ciphertext file, and the key file by, wherein:
elements of an encryption algorithm set are hash function and bit operation rule sets for an encryption operation; and
elements of a decryption algorithm set are hash function and bit operation rule sets for a decryption operation,
wherein any hash function and bit operation rule in the encryption algorithm set has a unique hash function and bit operation rule in the decryption algorithm set which is corresponding and reversible to the hash function and bit operation rule.

5. The method of claim 1, wherein the step S3 comprises:
negating partial or all binary bits of the plaintext or a key, and by means of pseudo-random sequences and chaotic signals generated by various key stream generators, and by means of various Boolean functions and any random files with uniform code distribution on a binary system, configuring a bit operation rule.

6. The method of claim 1, wherein in the step S3, the bit operation rule comprises at least one of the following operation rules:
rule 1: according to a true value bit or a false value bit of the key stream, negating partial binary bits of the plaintext;
rule 2: according to various Boolean functions, negating partial binary bits of the plaintext;
rule 3: according to a true value bit or a false value bit of another key stream, negating partial binary bits of an initial key stream; and
rule 4: according to various Boolean functions, negating partial binary bits of the initial key stream.

7. The method of claim 5, wherein the Boolean function comprises a combination of one or more mathematical formulas, wherein a specific bit meeting a formula of |C+X×i| MOD Y=Z is negated in a traversing process, in the formula: i is a serial number of the binary bit, C and X are integers, Y is a positive integer, and Z is an integer greater than or equal to 0 and less than Y, the specific bit comprises an odd bit, an even bit, and a binary bit with a remainder being zero when divided by a certain prime number Y.

8. The method of claim 1, further comprising:
creating corresponding plaintext encrypted random number, ciphertext encrypted random number, and key encrypted random number for the plaintext file, the ciphertext file, and the key file respectively, and generating corresponding working pointers according to values of the encrypted random numbers;
performing working pointer displacement reading on the plaintext file, the ciphertext file, and the key file; and
circularly traversing the working pointer for a plurality of times, and according to a value of the binary bit of the key stream pointed by the working pointer, iterating the plaintext file for a plurality of times to obtain the ciphertext file.

9. The method of claim 1, further comprising:
implementing the plaintext, a key, and a ciphertext by a round-robin queue structure;
allowing a length of the key file to be not necessarily equal to that of the plaintext file; and
intercepting partial bytes of the key file as the key, or using a circular key.

10. A computer device, comprising a memory, a processor, and a computer program stored on the memory and executable on the processor, wherein the processor, when executing the program, implements an encryption and decryption method based on a random hash and bit operation, comprising the following steps of:
S1: configuring a memory space, and preparing corresponding storage spaces for a plaintext file, a ciphertext file, and a key file, wherein the key file comes from an existing coding sequence and serves as a shared file for encryption and decryption;
S2: providing a reversible hash function set used for encryption and decryption, and then uniformly scattering the plaintext in a known binary random hash by an encryption hash function; and
S3: introducing a bit operation rule set, changing values of all or partial binary bits of the binary random hash by a bit operation, and mapping the values to a ciphertext space.

11. The computer device of claim 10, wherein the step S1 comprises:
initializing the plaintext file, loading the plaintext file needing to be encrypted, and setting a number of element codes of the key file, wherein a byte length of the key file is customizable, the number of the element codes of the key file is no more than a number of element codes of the plaintext file; and wherein the coding sequence generating the key file comes from at least one of an audio, a video, a picture, an image, a graph, a pseudo-random code, or a chaotic value.

12. The computer device of claim 10, wherein the step S2 comprises:
constructing the hash function set by a dynamic direct addressing method to avoid collision, so that conventional attack techniques comprising a dictionary attack and a birthday attack are invalid.

13. The computer device of claim 10, wherein the step S2 comprises: providing an algorithm program of encryption and decryption algorithm program sets to perform displacement reading on the plaintext file, the ciphertext file, and the key file by, wherein:
elements of an encryption algorithm set are hash function and bit operation rule sets for an encryption operation; and
elements of a decryption algorithm set are hash function and bit operation rule sets for a decryption operation,
wherein any hash function and bit operation rule in the encryption algorithm set has a unique hash function and bit operation rule in the decryption algorithm set which is corresponding and reversible to the hash function and bit operation rule.

14. The computer device of claim 10, wherein the step S3 comprises:
negating partial or all binary bits of the plaintext or a key, and by means of pseudo-random sequences and chaotic signals generated by various key stream generators, and by means of various Boolean functions and any random files with uniform code distribution on a binary system, configuring a bit operation rule.

15. The computer device of claim 10, wherein in the step S3, the bit operation rule comprises at least one of the following operation rules:
rule 1: according to a true value bit or a false value bit of the key stream, negating partial binary bits of the plaintext;
rule 2: according to various Boolean functions, negating partial binary bits of the plaintext;
rule 3: according to a true value bit or a false value bit of another key stream, negating partial binary bits of an initial key stream; and
rule 4: according to various Boolean functions, negating partial binary bits of the initial key stream.

16. The computer device of claim 14, wherein the Boolean function comprises a combination of one or more mathematical formulas, wherein a specific bit meeting a formula of |C+X×i| MOD Y=Z is negated in a traversing process, in the formula: i is a serial number of the binary bit, C and X are integers, Y is a positive integer, and Z is an integer greater than or equal to 0 and less than Y, the specific bit comprises an odd bit, an even bit, and a binary bit with a remainder being zero when divided by a certain prime number Y.

17. The computer device of claim 10, wherein the method further comprises:
creating corresponding plaintext encrypted random number, ciphertext encrypted random number, and key encrypted random number for the plaintext file, the ciphertext file, and the key file respectively, and generating corresponding working pointers according to values of the encrypted random numbers;
performing working pointer displacement reading on the plaintext file, the ciphertext file, and the key file; and
circularly traversing the working pointer for a plurality of times, and according to a value of the binary bit of the key stream pointed by the working pointer, iterating the plaintext file for a plurality of times to obtain the ciphertext file.

18. The computer device of claim 10, wherein the method further comprises:
implementing the plaintext, a key, and a ciphertext by a round-robin queue structure;
allowing a length of the key file to be not necessarily equal to that of the plaintext file; and
intercepting partial bytes of the key file as the key, or using a circular key.
